(19) United States
(12) Patent Application Publication
(10) Pub. No.: US 2017/0096047 A1
(43) Pub. Date: Apr. 6, 2017

(54) AIR CONDITIONER FOR VEHICLE

(71) Applicant: HANON SYSTEMS, Daejeon (KR)

(72) Inventors: Yong Eun SEO, Daejeon (KR); Hyung Joo KIM, Daejeon (KR); Tae Wan KIM, Daejeon (KR); Tae Yun KONG, Daejeon (KR); Jeong Hun SEO, Daejeon (KR); Sae Dong EOM, Daejeon (KR); Jae Hwan JUNG, Daejeon (KR)

(21) Appl. No.: 15/286,808

(22) Filed: Oct. 6, 2016

(30) Foreign Application Priority Data
Oct. 6, 2015 (KR) 10-2015-0140325
Oct. 6, 2015 (KR) 10-2015-0140326

(51) Int. Cl. B60H 1/00; B60H 1/24

(52) U.S. Cl. CPC B60H 1/00521; B60H 1/00564; B60H 1/00678; B60H 1/246

(57) ABSTRACT

Disclosed is an air conditioner for a vehicle in which power transmitting means, such as an actuator, an arm and a lever, does not protrude outwardly from an air-conditioning case. The air conditioner includes: a case having an air passageway formed therein; a door disposed inside the case to adjust the degree of opening of the air passageway; an actuator for providing driving power for the door; and an accommodating part disposed on the case for accommodating the actuator therein, wherein the actuator is located on the same level with the case side by side and is formed to be level with or shorter than the case.

### BACKGROUND OF THE INVENTION

Field of the Invention

The present invention relates to an air conditioner for a vehicle, and more particularly, to an air conditioner for a vehicle which includes an actuator providing driving power for a door adjusting the degree of opening of an air passageway and a lever and an arm for transmitting power.

Background Art

In general, an air conditioner for a vehicle is an apparatus for cooling or heating the interior of the vehicle by cooling or heating through the process of introducing outdoor air into the interior of the vehicle or circulating indoor air of the vehicle. That is, Such an air conditioner for a vehicle is configured such that air is induced to the interior of the vehicle by an air blower and the induced air selectively passes through a heater core according to opening and closing of a temp door after passing through an evaporator, in which refrigerant flows, and then, is selectively blown to parts of the interior of the vehicle by a door.

FIG. 1 is a perspective view showing a connection structure of a door and an actuator of a conventional air conditioner for a vehicle, and FIG. 2 is a sectional view showing the connection structure of the door and the actuator of the conventional air conditioner.

As shown in FIGS. 1 and 2, a door 1 is rotatably connected to the inside of an air-conditioning case 6. An arm 2 is connected to a rotary shaft 3 of the door 1, and a pin of a lever 4 is inserted into a slot of the arm 2. A driving shaft of an actuator 5 is connected to the lever 4.

When electric power is applied to the actuator 5 to rotate the driving shaft, the lever 4 rotates on the driving shaft of the actuator 5, and the arm 2 rotates on the rotary shaft 3 of the door 1 as the pin of the lever 4 moves along the slot of the arm 2. The door 1 rotates on the rotary shaft 3 inside the air-conditioning case 6.

The arm 2 is joined to the rotary shaft 3 of the door 1 outside the air-conditioning case 6, the lever 4 is assembled to the outside of the arm 2, and the actuator 5 is joined to the outside of the lever 4. The components are assembled in the order of the arm 2, the lever 4 and the actuator 5. Moreover, based on the air-conditioning case 6, the arm 2, the lever 4 and the actuator 5 are arranged to protrude outwardly in the length direction of the rotary shaft 3 of the door 1.

However, the conventional air conditioner for the vehicle has a disadvantage in that the entire size of the air conditioner is increased because the door and the power transmitting means, such as the actuator, the lever and the arm, are assembled to the outer face of the air-conditioning case in a stack type and protrude as high as the outermost surface of the actuator to a predetermined height (h). Furthermore, the conventional air conditioner for the vehicle has another disadvantage in that workers cannot assemble the components smoothly when they assemble the components in a working environment narrower than the maximum protrusion boundary condition of the components. Additionally, the conventional air conditioner for the vehicle has a further disadvantage in that the components may be deformed or damaged by external shock or load due to the structure that the arm, the lever and the actuator protrude outwardly from the air-conditioning case.

In the meantime, in order to cool or heat the rear seats of a vehicle, a rear air conditioner for a vehicle may be installed at the side of a console. FIG. 3 is a perspective view showing a conventional rear air conditioner for a vehicle.

As shown in FIG. 3, the conventional rear air conditioner 1100 includes cooling means, heating means, air adjusting door and a mode door. The air-conditioning case includes an air passageway formed therein and a blower unit for forcedly blowing air toward the air passageway formed inside the air-conditioning case. The cooling means and the heating means are mounted inside the air-conditioning case in order. The cooling means may be an evaporator, and the heating means may be a heater core. A temperature-adjusting door is mounted between the evaporator and the heater core to adjust the degree of opening of a cold air passageway bypassing the heater core and the degree of opening of a warm air passageway passing through the heater core. The mode door adjusts the degree of opening of an outlet.

The rear air conditioner 1100 includes a mode duct 1200. The rear air conditioner 1100 and the mode duct 1200 are connected with each other through a connection duct 1120. A floor duct 1130 and a B-pillar duct 1140 are connected to the mode duct 1200. The air discharged from the rear air conditioner 1100 flows toward a vent port 1150 or the mode duct 1200 by a selective operation of the mode door mounted inside the air-conditioning case. The air discharged to the mode duct 1200 flows toward the floor duct 1130 or the B-pillar duct 1140 by a selective operation of the door mounted inside the mode duct 1200. The mode duct 1200 includes an actuator 1250 for operating the door mounted therein.

However, the conventional rear air conditioner for the vehicle has a disadvantage in that the mode duct may be damaged when a worker steps on the mode duct during a car assembly and may be damaged when relatively heavy things are loaded on the rear seat of the vehicle because the mode duct 1200 is located on the bottom of a vehicle floor panel, there are different gaps at different locations between the floor panel and the mode duct and there is no structure for fixing the mode duct.

### SUMMARY OF THE INVENTION

Accordingly, the present invention has been made in view of the above-mentioned problems occurring in the prior art, and it is an object of the present invention to provide an air conditioner for a vehicle in which power transmitting means, such as an actuator, an arm and a lever, do not protrude outwardly from an air-conditioning case.

It is another object of the present invention to provide an air conditioner for a vehicle a strengthening structure is mounted at an optimized position in order to minimize deformation of a mode duct.

To accomplish the above object, according to the present invention, there is provided an air conditioner for a vehicle including: an air-conditioning case having an air passageway formed therein; a door disposed inside the air-conditioning case to adjust the degree of opening of the air passageway; an actuator for providing driving power for the door; and an accommodating part disposed on the air-conditioning case for accommodating the actuator therein, wherein the actuator is located on the same level with the air-conditioning case side by side and is formed to be level with or shorter than the air-conditioning case.

The air conditioner for the vehicle according to preferred embodiments of the present invention can reduce the entire size of the air conditioner, prevent deformation or damage of the components by external shock or load, and can be operated stably.

In addition, the air conditioner for the vehicle according to preferred embodiments of the present invention can prevent deformation or damage by a load applied to the floor panel because a vertical rigidity of the mode duct is reinforced, and enhance structural stability by minimizing and uniformly keeping gaps between the mode duct and the floor panel.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a connection structure of a door and an actuator of a conventional air conditioner for a vehicle;

FIG. 2 is a sectional view showing the connection structure of the door and the actuator of the conventional air conditioner;

FIG. 3 is a perspective view showing a conventional rear air conditioner for a vehicle;

FIG. 4 is a front perspective view showing a state where an actuator is mounted on an air-conditioning case of an air conditioner for a vehicle according to a first preferred embodiment of the present invention;

FIG. 5 is a rear perspective view showing the state where the actuator is mounted on the air-conditioning case of the air conditioner for a vehicle according to the first preferred embodiment of the present invention;

FIG. 6 is a sectional view taken along the line of A-A of FIG. 4;

FIG. 7 is a perspective view showing a mode duct of an air-conditioning case of an air conditioner for a vehicle according to a second preferred embodiment of the present invention;

FIG. 8 is a plane sectional view showing the inside of the mode duct of the air conditioner for the vehicle according to the second preferred embodiment of the present invention;

FIG. 9 is a side sectional view showing the inside of the mode duct of the air conditioner for the vehicle according to the second preferred embodiment of the present invention;

FIG. 10 is a plan view showing the inside of the mode duct of the air conditioner for the vehicle according to the second preferred embodiment of the present invention; and

FIG. 11 is a perspective view showing a state where the actuator is separated from the mode duct of the air conditioner for the vehicle according to the second preferred embodiment of the present invention.

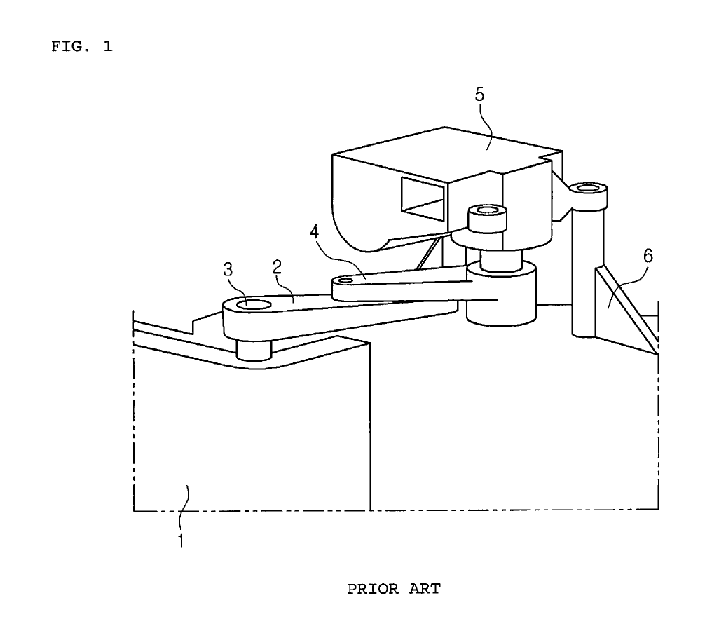

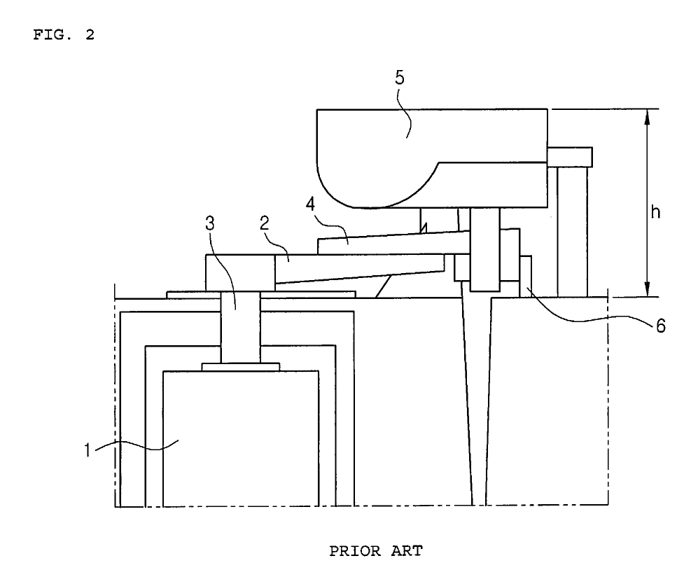

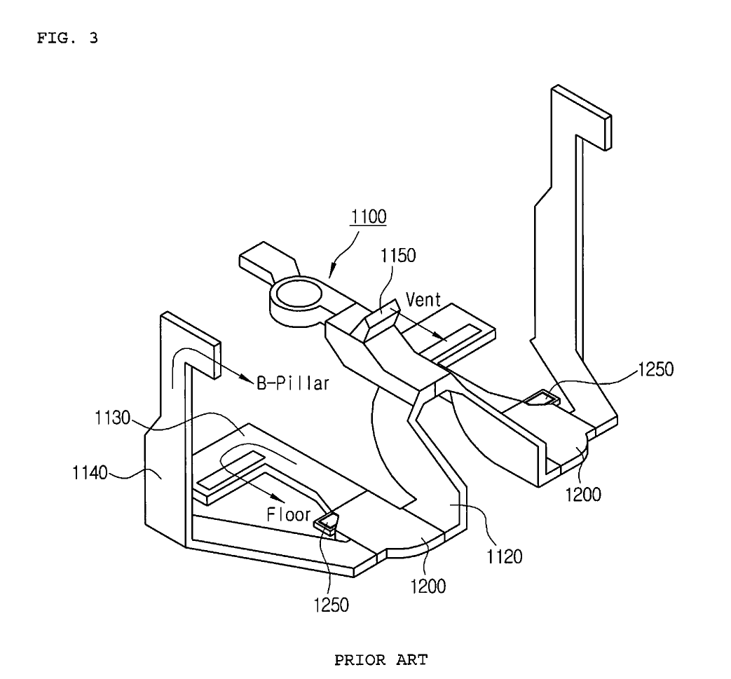

### DETAILED DESCRIPTION OF THE PREFERRED EMBODIMENT

Hereinafter, an air conditioner for a vehicle according to preferred embodiments of the present invention will be described in detail with reference to the attached drawings.

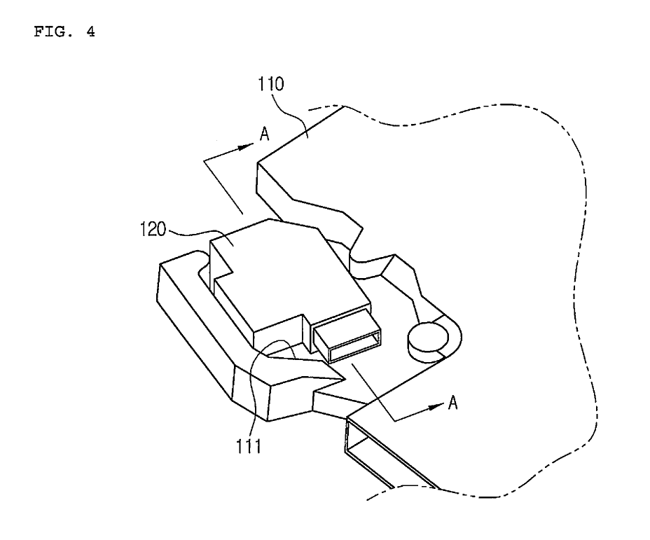

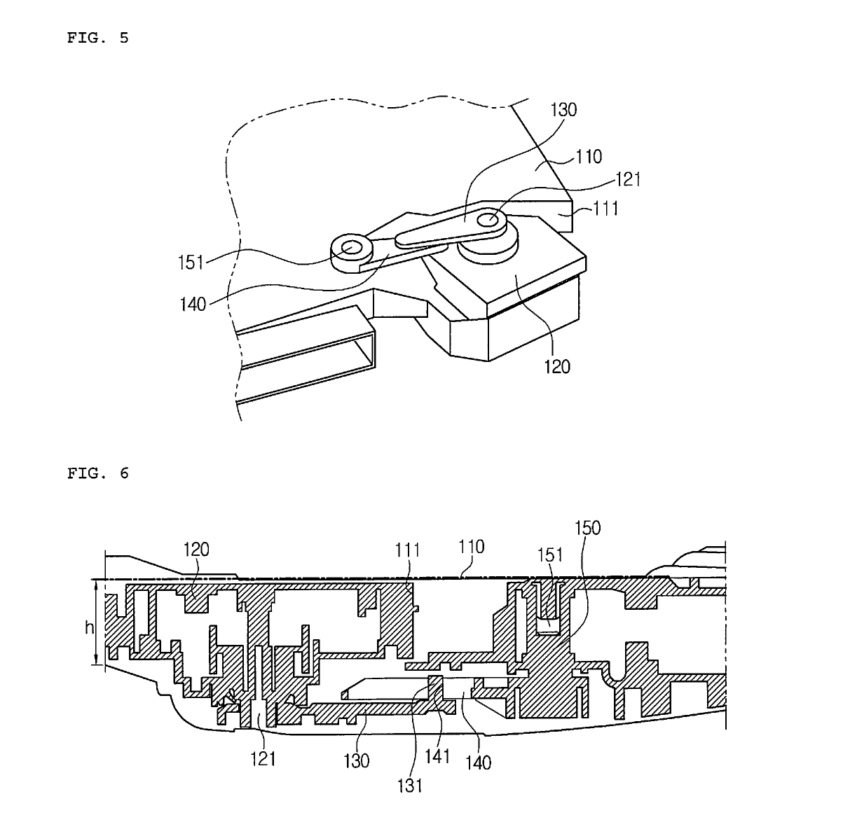

FIG. 4 is a front perspective view showing a state where an actuator is mounted on an air-conditioning case of an air conditioner for a vehicle according to a first preferred embodiment of the present invention, FIG. 5 is a rear perspective view showing the state where the actuator is mounted on the air-conditioning case of the air conditioner for a vehicle according to the first preferred embodiment of the present invention, and FIG. 6 is a sectional view taken along the line of A-A of FIG. 4.

As shown in FIGS. 4 to 6, the air conditioner for a vehicle according to the first preferred embodiment of the present invention includes a case 110, a door 150, an actuator 120 and power transmitting means.

The case 110 may be a case of a mode duct which will be described in another preferred embodiment of the present invention. The case 110 has an air passageway formed therein. The door 150 is disposed inside the case 110 to adjust the degree of opening of the air passageway. The actuator 120 provides driving power for the door 150.

The case 110 has an accommodating part for accommodating the actuator 120 therein. The actuator 120 is accommodated in the accommodating part of the case 110, and as shown in FIGS. 4 to 6, the accommodating part may be in the form of an accommodating recess 111. The accommodating recess 111 may be formed in such a way that a part of the case 110 is cut or dented inwardly. The protrusion of the outer face of the actuator 120 located in the accommodating recess 11 is shorter than or level with the protrusion of the outer face of the case 110.

The actuator 120 is located on the same plane with the case 110 and is shorter than or level with the case 110. In other words, because the outer face of the case 110 is formed to be higher than or level with the outer face of the actuator 120, the actuator 120 does not protrude outwardly from the case 110 so that the entire size of the air conditioner can be reduced. Moreover, because the actuator 120 does not protrude outwardly from the case 110, the air conditioner for the vehicle according to the present invention can prevent deformation or damage of components by external shock or load. Preferably, the upper side of the actuator 120 and the upper side of the case 110 are located on the same line. Therefore, the air conditioner for the vehicle according to the preferred embodiment of the present invention can maximize space utilization inside the limited space of the air-conditioning case without protrusion of the actuator to the outside.

The power transmitting means connect a driving shaft 121 of the actuator 120 and a rotary shaft 151 of the door 150 with each other to transmit power. The power transmitting means are accommodated in the accommodating part. The power transmitting means include: an arm 140 joined to the rotary shaft 151 of the door 150; and a lever 130 connected to the arm 140 and joined to the driving shaft 121 of the actuator 120.

The arm 140 is joined to the rotary shaft 151 of the door 150 to be rotated, and the pin 131 of the lever 130 is connected to the slot 141 of the arm 140 to be able to slide. The lever 130 is joined to the driving shaft 121 of the actuator 120. When the driving shaft 121 of the actuator 120 rotates, the lever 130 rotates on the driving shaft 121 and the arm 130 is also rotated by sliding of the pin 131 of the lever 130, so that the door 150 rotates on the rotary shaft 151.

The actuator 120, the arm 140 and the lever 130 are all accommodated in the accommodating recess 111 and arranged to be lower than the outer boundary surface of the case 110. That is, the arm 140 and the lever 130 are respectively formed on the lower side of the actuator 120 and the lower side of the case 110. Therefore, the arm 140 and the lever 130 do not protrude outwardly from the case 110 and are operated inside the inner space of the case 110 so as to be protected from the external shock or foreign matters.

Therefore, because the actuator 120, the arm 140 and the lever 130 are all operated inside the case 110 without protruding outwardly from the case 110, the air conditioner for the vehicle according to the present invention can reduce the entire size of the air conditioner and can be operated stably regardless of the external shock or load. Moreover, the actuator 120, the arm 140 and the lever 130 are relatively safe from infiltration of foreign matters from the outside.

Such a structure can be achieved by an optimized arrangement of the actuator 120, the arm 140 and the lever 130. That is, the driving shaft 121 of the actuator 120 and the rotary shaft 151 of the door 150 are arranged side by side to face each other. The actuator 120, the arm 140 and the lever 130 are formed to be level with or lower than the outer face of the case 110 in the length direction of the rotary shaft 151, namely, in the height direction (h) in FIG. 5.

Moreover, the actuator 120, the power transmitting means and the door 150 are arranged side by side in the radial direction of the rotary shaft 151 of the door. Through such a structure, the package of the air conditioner can be designed intensively not only in the height direction (h) but also in the length direction orthogonal to the height direction (h). Additionally, the air conditioner for the vehicle according to the present invention can minimize deformation of the components and can be operated stably because the actuator 120, the arm 140 and the lever 130 are all operated in the accommodating part formed inside the case 110.

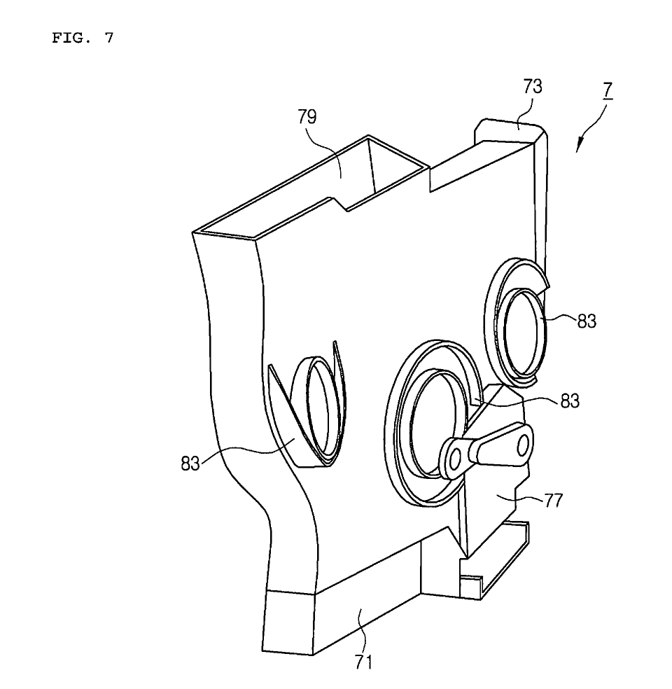

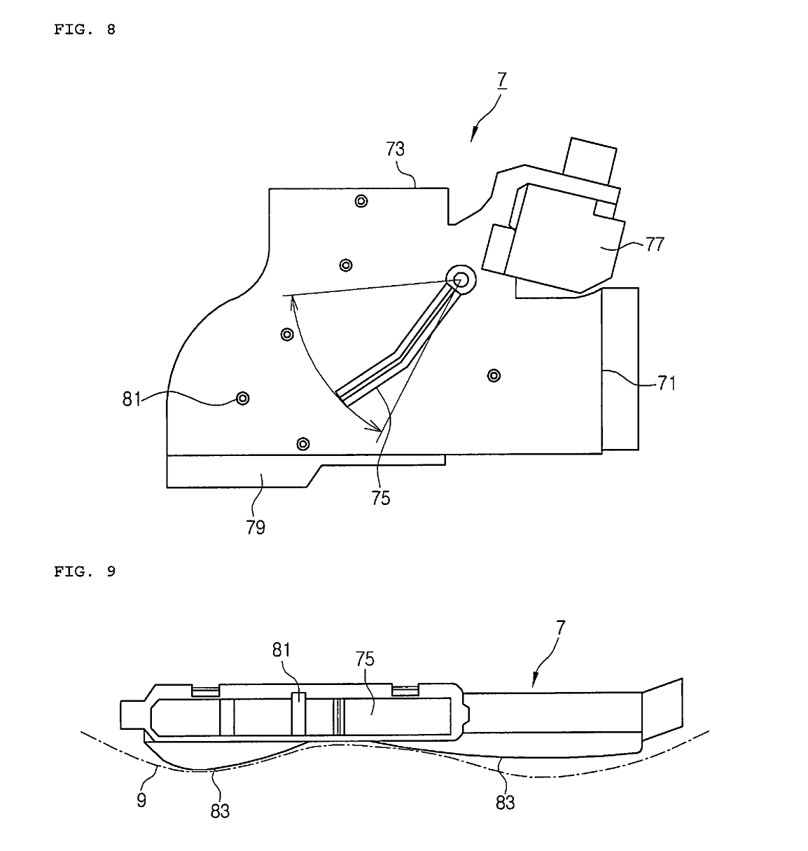

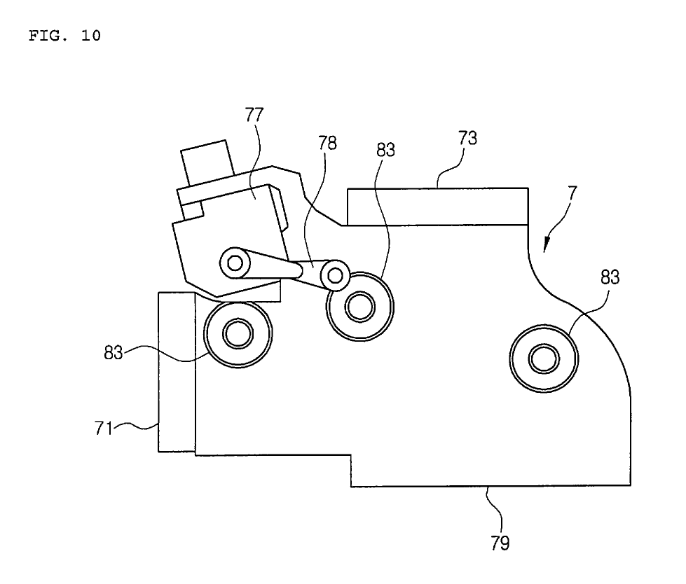

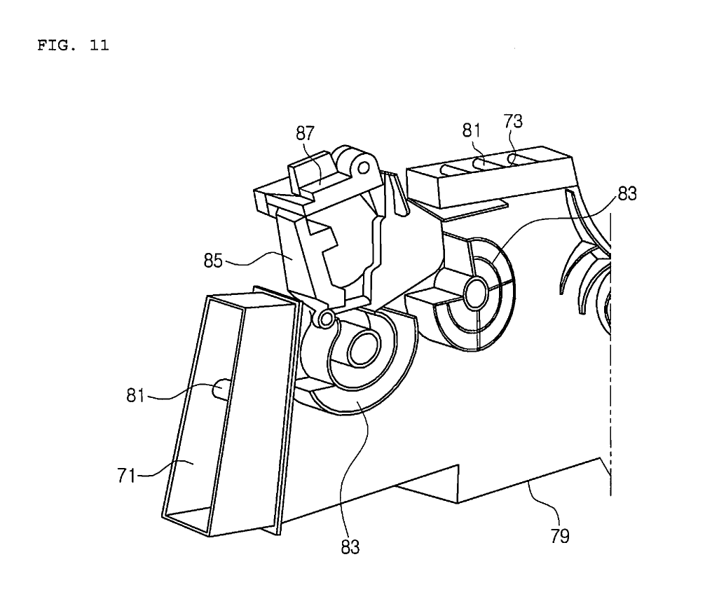

FIG. 7 is a perspective view showing a mode duct of an air-conditioning case of an air conditioner for a vehicle according to a second preferred embodiment of the present invention, FIG. 8 is a plane sectional view showing the inside of the mode duct of the air conditioner for the vehicle according to the second preferred embodiment of the present invention, FIG. 9 is a side sectional view showing the inside of the mode duct of the air conditioner for the vehicle according to the second preferred embodiment of the present invention, FIG. 10 is a plan view showing the inside of the mode duct of the air conditioner for the vehicle according to the second preferred embodiment of the present invention, and FIG. 11 is a perspective view showing a state where the actuator is separated from the mode duct of the air conditioner for the vehicle according to the second preferred embodiment of the present invention.

Referring to FIGS. 7 to 11, the air conditioner for the vehicle according to the second preferred embodiment of the present invention is a rear air conditioner installed at the side of a console at the rear seat of the vehicle, and includes an air-conditioning unit having an air-conditioning case, cooling means, heating means, air adjusting door, a mode door and so on.

The air-conditioning case has an inlet formed at an entrance and an outlet formed at an exit, so that air induced through the inlet is discharged to the outlet. The air-conditioning case has an air passageway formed therein. Furthermore, a blower unit is disposed at the inlet of the air-conditioning case in order to forcedly blow air toward the inside of the air-conditioning case.

The cooling means and the heating means are mounted inside the air-conditioning case in order. In this instance, the cooling means is an evaporator, and the heating means is a heater core. A temperature adjusting door is mounted between the evaporator and the heater core to adjust the degree of opening of a cold air passageway bypassing the heater core and the degree of opening of a warm air passageway passing through the heater core. Additionally, a mode door adjust the degree of opening of the outlet.

The air conditioner for the vehicle according to the second preferred embodiment of the present invention includes a mode duct 7. The mode duct 7 is mounted on the bottom of a floor panel 9 of the vehicle. The mode duct 7 receives air discharged from the air-conditioning unit and selectively discharges the received air to at least one of a floor outlet 71 and a B-pillar outlet 73. A door 75 is disposed inside the mode duct 7. The door 75 controls air volume discharged to the floor outlet 71 and the B-pillar outlet 73 while rotatably operating. In the first preferred embodiment illustrated in FIGS. 4 to 6, the case may be the case of the mode duct 7.

The air conditioner for the vehicle includes a strengthening part. The strengthening part vertically extends inside or outside the mode duct 7 to support the mode duct 7.

In more detail, the air conditioner for the vehicle includes a first strengthening part 81. The first strengthening part 81 is in the form of a boss, and extends in the vertical direction inside the mode duct 7. The first strengthening part 81 supports upper and lower sides of the inside of the mode duct 7, and at least one first strengthening part 81 is formed. The first strengthening part 81 is formed outside the working radius of the door 75.

Because the first strengthening part 81 is disposed outside the working radius of the door 75, it can effectively reinforce rigidity of the mode duct in the vertical direction without any interference with the door.

Moreover, the mode duct 7 further includes a second strengthening part 83 formed outside the mode duct 7. The second strengthening part 83 protrudes in the downward direction of the mode duct 7. Because the mode duct 7 is formed at the lower portion of the driver seat or the passenger seat, the feet of a passenger who sits on the rear seat may touch the mode duct 7. Therefore, the second strengthening part 83 which is in a protrusion form is formed to protrude in the downward direction of the mode duct to prevent contact with the passenger.

In more detail, the second strengthening part 83 protrudes and extends from the mode duct 7 toward a gap between the mode duct 7 and the floor panel 9 in the vertical direction. Because the second strengthening part 83 protrudes and extends to the outside of the mode duct 7 in the vertical direction, the gap between the mode duct 75 and the floor panel 9 becomes minimized. Therefore, the second strengthening part 83 can prevent damage of the mode duct when a load is applied to the floor panel 9.

The second strengthening part 83 has a round section, and a plurality of the second strengthening parts 83 are arranged to form concentric circles. The second strengthening part 83 vertically extends from the mode duct 7 toward the floor panel 9 in such a way as to effectively disperse the load due to the circular cross section and to maximize dispersion of the load through the concentric arrangement of the second strengthening parts 83.

In the meantime, the mode duct 7 includes an actuator 77 for operating the door 75. The mode duct 7 is generally in the form of a relative thin plate and has an air passageway formed therein. The mode duct 7 has an inlet 79 formed at one side to be connected with the air-conditioning case and a B-pillar outlet 73 formed at the side facing the inlet 79. A floor outlet 71 is formed at the side of the mode duct which is orthogonal to the inlet 79 and the B-pillar outlet 73.

In other words, the inlet 79, the floor outlet 71 and the B-pillar outlet 73 are arranged at an interval of about 90 degrees. In this instance, the rotary shaft of the door 75 is located between the floor outlet 71 and the B-pillar outlet 73 and is mounted to be able to rotate. Moreover, the actuator 77 is joined to a place, which is adjacent to the door 75, between the floor outlet 71 and the B-pillar outlet 73. The actuator 77 is joined to the outside of the mode duct 7, and the rotary shaft of the door and the driving shaft of the actuator are connected with each other through the power transmitting means, such as the lever 78.

The actuator 77 is joined to a lateral part of the mode duct 7 side by side. In this instance, the mode duct 7 has an accommodating part formed at a side thereof, and the actuator 77 is joined to the accommodating part side by side. The second strengthening part 83 is formed to surround the accommodating part. A plurality of the second strengthening parts 83 are arranged to surround the accommodating part to protect the actuator.

Furthermore, the accommodating part is on one side of the mode duct 7, and the second strengthening part 83 is formed on the other side of the mode duct 7 at the same level with the accommodating part, which is formed around the accommodating part. In this embodiment, two second strengthening parts 83 are formed to surround the accommodating part, and the other one is formed at the opposite side of the accommodating part. Through the above structure, the air conditioner can evenly disperse and stably support the load while adjusting balance to both sides of the mode duct.

Additionally, because the actuator 77 is joined to the lateral part of the mode duct 7 side by side, the actuator 77 does not protrude in the upward direction of the mode duct 7 and is prevented from being deformed or damaged by a vertical load. In addition, because the mode duct 7 does not protrude as much as the volume of the actuator 77, the vertical width is minimized.

Moreover, the mode duct 7 includes a support part 85 and a rubber part 87. The support part 85 is joined to the lateral part of the mode duct 7 and covers some of a lateral part of the actuator 77 to support it. The rubber part 87 is made of an elastic material, is joined to the lateral part of the mode duct 7, and covers some of the other lateral part of the actuator 77.

The support part 85 and the rubber part 87 can prevent that the actuator 77 is separated from the mode duct 8 in the lateral direction when a load is applied to the floor panel 9 of the vehicle, and minimize deformation and damage of the actuator 77 and the lever 78 by absorbing vibration.

As described above, while the present invention has been particularly shown and described with reference to the example embodiments thereof, it will be understood by those of ordinary skill in the art that the above embodiments of the present invention are exemplified and various changes, modifications and equivalents may be made therein without changing the essential characteristics and scope of the present invention. Therefore, it would be understood that the protective scope of the present invention is defined by the technical idea of the following claims.

What is claimed is:

1. An air conditioner for a vehicle which includes: a case having an air passageway formed therein; a door disposed inside the case to adjust the degree of opening of the air passageway; and an actuator for providing driving power for the door, the air conditioner comprising:
an accommodating part disposed on the case for accommodating the actuator therein,
wherein the actuator is located on the same level with the case side by side and is formed to be level with or shorter than the case.

2. The air conditioner according to claim 1, further comprising:
power transmitting means which connect a driving shaft of the actuator and a rotary shaft of the door with each other to transmit power, the power transmitting means being accommodated in the accommodating part.

3. The air conditioner according to claim 2, wherein the power transmitting means comprise: an arm joined to the rotary shaft of the door; and a lever connected to the arm and joined to the driving shaft 121 of the actuator.

4. The air conditioner according to claim 1, wherein the driving shaft of the actuator and the rotary shaft of the door are arranged side by side to face each other.

5. The air conditioner according to claim 2, wherein the actuator, the power transmitting means and the door are arranged side by side in the radial direction of the rotary shaft of the door.

6. The air conditioner according to claim 1, wherein the upper side of the actuator and the upper side of the case are located on the same line.

7. The air conditioner according to claim 3, wherein the arm and the lever are respectively formed on the lower side of the actuator and the lower side of the case.

8. The air conditioner according to claim 1, further comprising:
a mode duct which receives air discharged from an air-conditioning unit to discharge the received air and is mounted on the bottom of a floor panel of the vehicle; and
a strengthening part which vertically extends inside or outside the mode duct to support the mode duct.

9. The air conditioner according to claim 8, wherein a first strengthening part is formed inside the mode duct to be formed outside the working radius of the door.

10. The air conditioner according to claim 8, wherein a second strengthening part is formed outside the mode duct to protrude in the downward direction of the mode duct.

11. The air conditioner according to claim 10, wherein the second strengthening part has a round section, and a plurality of the second strengthening parts are arranged to form concentric circles.

12. The air conditioner according to claim 11, wherein the second strengthening part is formed to surround the accommodating part.

13. The air conditioner according to claim 12, wherein the accommodating part is on one side of the mode duct, and the second strengthening part is formed on the other side of the mode duct at the same level with the accommodating part, which is formed around the accommodating part.

14. The air conditioner according to claim 8, wherein the mode duct comprises:
a support part which is joined to a lateral part of the mode duct and covers some of a lateral part of the actuator to support the actuator; and
a rubber part which is made of an elastic material, is joined to the lateral part of the mode duct, and covers some of the other lateral part of the actuator.
